(19) United States
(12) Patent Application Publication
(10) Pub. No.: US 2026/0100141 A1
(43) Pub. Date: Apr. 9, 2026

(54) RUBRIC ENGINE(S) FOR GENERATION OF ASSESSMENT FRAMEWORKS

(71) Applicant: Microsoft Technology Licensing, LLC, Redmond, WA (US)

(72) Inventors: Murtuza Sarfraz SHAKIR, Sammamish, WA (US); Dipak Chand BOYED, Bellevue, WA (US); Jonathan ESTERLY, Woodinville, WA (US); Merav MOFAZ, Tel Aviv (IL); Montana Jay FERRIS, Redmond, WA (US); Leif Christian BRENNE, Snoqualmie, WA (US); Richard Tuan Vu LE, Seattle, WA (US); Bivas MAITI, Seattle, WA (US); Chad SHEETS, Bellevue, WA (US)

(21) Appl. No.: 18/905,611

(22) Filed: Oct. 3, 2024

(51) Int. Cl. G09B 7/02; G06Q 50/20

(52) U.S. Cl. CPC G09B 7/02; G06Q 50/205

(57) ABSTRACT

Systems and methods for a rubric engine for providing a rubric engine for generation of customized and tailored rubrics are provided herein. In an example, the rubric engine may receive, from a client device, an indication to generate a rubric for an assignment. The rubric engine may determine an assignment type for the assignment and one or more evaluation criteria for the rubric based on the assignment type. In some cases, the rubric engine may also determine a rubric scale for the rubric and/or audience context for the assignment. Responsive to these determinations, the rubric engine may generate the rubric for the assignment based on the evaluation criteria and the audience context for the assignment. The rubric may include an assessment for each of the one or more evaluation criteria across the rubric scale. Once generated, the rubric engine may associate the rubric with the assignment.

### TECHNICAL FIELD

Aspects of the disclosure are related to the field of computer software applications and services and, in particular, to rubric engines for generation of assessment frameworks within learning environments.

### BACKGROUND

A rubric is a structured tool used in educational settings to clearly outline the criteria and standards for assessing student performance on assignments, projects, or exams. It typically breaks down the various components of a task, detailing what is expected at each level of achievement. This provides students with a transparent guide to understand what is required for success, enabling them to focus their efforts on meeting specific objectives. Instructors benefit from rubrics as they offer a consistent and objective framework for grading, ensuring fairness and clarity in evaluation. Rubrics also foster constructive feedback, helping students identify areas of strength and opportunities for improvement in their learning journey.

While rubrics are valuable tools for standardizing assessment, they also present certain challenges, particularly when applied in a one-size-fits-all manner. Traditional rubrics are often standardized, meaning that the same assessment criteria may be applied, regardless of the type or content of an assignment and/or the classroom population (e.g., grade level, age). This standardization can lead to a disconnect between the rubric's criteria and the specific features of the assignment or abilities of the individuals being assessed. As a result, the rubric may fail to accurately reflect the quality of completed work or the learning outcomes that are most relevant to a particular context. This one-size-fits-all approach can also stifle creativity and discourage critical thinking, as assessed individuals may feel compelled to conform to the rubric's narrow guidelines rather than explore innovative or personalized approaches to the assignment. Ultimately, while standardized rubrics can offer consistency, they may not always provide the most effective or fair means of assessment across diverse educational settings.

As such, there is a need for a rubric engine, and its related functions, for generating assessment frameworks that provide a tailored and customized evaluation of assignments within learning environments.

### SUMMARY

Technology disclosed herein includes software applications and services that provide a rubric engine, and its related functions, for generation of assessment frameworks, such as rubrics, within learning environments. In particular, the rubric engine allows for generation of a rubric that is customized to the assignment at hand and tailored to the population (e.g., students) performing the assignment. As will be described in greater detail below, responsive to receiving an indication to generate a rubric for an assignment, the rubric engine may determine an assignment type for the rubric. Based on the assignment type, and in some cases the assignment instructions, the rubric engine may generate one or more evaluation criteria for the rubric.

In some embodiments, in addition to determining the evaluation criteria, the rubric engine may determine a rubric scale and audience context of the assignment. The audience context may include information on the population of individuals performing the assignment, such as a grade level, age, or academic proficiency of the students assigned to complete the assignment. Based on the evaluation criteria and audience context, the rubric engine may generate a rubric for the assignment. The rubric may include an assessment for each of the evaluation criteria across the rubric scale. Once generated, the rubric engine may associate the rubric with the assignment for grading and evaluation purposes.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a rubric engine for generating a customized rubric tailored to an assignment, according to an embodiment herein;

FIG. 2 illustrates a brief operational scenario to further highlight an application of the rubric engine, according to an embodiment provided herein;

FIG. 3 illustrates a system for providing a rubric engine and related functions, according to an embodiment herein;

FIG. 4 illustrates a process for providing the rubric engine and its related functions, according to an embodiment herein;

FIG. 5 illustrates an example assignment prompt, according to an embodiment herein;

FIG. 6 illustrates an example prompt providing options for generating a rubric, according to an embodiment herein;

FIG. 7 illustrates an example prompt for creating a rubric, according to an embodiment herein;

FIG. 8 illustrates another example prompt for creating a rubric, according to an embodiment herein;

FIG. 9 illustrates an example rubric generated by a rubric engine, according to an embodiment herein;

FIG. 10 illustrates an example prompt for defining new criteria to be added to a draft rubric, according to an embodiment herein;

FIG. 11 illustrates example modification options for the rubric in FIG. 9, according to an embodiment herein;

FIG. 12 illustrates an example prompt for modifying a rubric, according to an embodiment herein;

FIG. 13 illustrates the rubric of FIG. 9 with point values added, according to an embodiment herein;

FIG. 14 illustrates an example grading assignment including a customized rubric, according to an embodiment herein; and

FIG. 15 shows an example client device suitable for providing a rubric engine and related functions, according to an embodiment herein.

### DETAILED DESCRIPTION

Rubrics are widely recognized tools in educational settings, designed to provide clear criteria for assessing students'work products and task performance. They serve as a framework that outlines expectations and standards, helping both educators and students understand what constitutes quality work. By breaking down assignments into specific components, rubrics enable a more structured and transparent evaluation process. This not only facilitates consistent grading but also provides students with valuable feedback on their strengths and areas for improvement. The use of rubrics has become a common practice across various educational levels, from elementary schools to higher education, and across different subjects and disciplines.

Despite their widespread use, traditional or conventional rubrics often face criticism for being overly generic and insufficiently tailored to the specific nuances of different assignments. These rubrics may not fully consider the unique content, objectives, or skills required for particular tasks, leading to assessments that can feel disconnected from the actual work being evaluated. Additionally, the one-size-fits-all approach can fail to account for the diverse needs and abilities of different student populations. As a result, traditional rubrics can sometimes provide feedback that is too vague or broad, limiting their effectiveness in guiding student improvement and accurately reflecting the quality of their work.

Another significant challenge with rubrics is the time and effort required for their creation. Developing a well-crafted rubric that is specific, clear, and aligned with the assignment objectives can be a labor-intensive process for educators. This time investment often leads to the repeated use of generic or outdated rubrics, even when they may not be fully applicable to the current assignment or task. The pressure to manage time efficiently can result in educators relying on standard rubrics that may not capture the full scope of what is being assessed, potentially undermining the rubric's purpose of providing precise and meaningful evaluation criteria.

As can be appreciated, using a standardized or generic rubric for assessing a work product or performed task can lead to several negative outcomes, both for the assessed individuals (e.g., students) and the assessing individuals (e.g., educators). Generic rubrics, which are often designed to be broadly applicable, may fail to capture the specific skills, knowledge, or objectives that an assignment is meant to assess. This can result in feedback that is too general or unrelated to the actual work, leaving students unsure of how to improve or what areas they need to focus on. Moreover, the lack of alignment between the rubric and the task can cause inconsistencies in grading, leading to potential unfairness or misunderstanding of what is expected. Ultimately, this undermines the educational value of the assessment process, as students may not fully grasp the learning objectives or feel motivated to meet the standards set by an unclear rubric

To address these and other shortcomings, an example rubric engine, and its related functions, is provided herein to generate a rubric that is customized and tailored to a specific assignment and/or assessed population or audience. As will be expanded on below, the rubric engine provided herein may identify an indication to generate a rubric for a respective assignment. Responsive to the indication, which may be a request to generate the rubric, the rubric engine may determine an assignment type for the assignment. Based on the assignment type, the rubric engine may determine evaluation criteria for the rubric. In some cases, the evaluation criteria may be generated by a content generator that is in operational communication with the rubric engine, while in other embodiments, the creating user, which is often an educator, may input or modify the evaluation criteria for the rubric. In some embodiments, the rubric engine may determine an audience context for the assignment. The audience context may include information regarding the population of individuals being assessed (e.g., assessed population). This may include information such as the grade level or ability level of the individuals being assessed or may include the ages, locations, or resources available to the individuals being assessed.

Based on the evaluation criteria and/or the audience context, the rubric engine may generate a rubric for the assignment. For example, the rubric engine may generate a prompt requesting a rubric to assess the evaluation criteria across a rubric scale for the assessed population identified by the audience context. In some cases, the prompt may include details about the assignment, such as the assignment instructions or relevant documents (e.g., assigned reading material) to further tailor the rubric to the specific task. The prompt may be submitted to a content generator that may, in turn, generate a response including a rubric. The rubric may include an assessment for each of the evaluation criteria across the rubric scale. Each of the assessments may be tailored to the specific assignment and the assessed population based on the audience context.

By generating a customized and tailored rubric, the rubric engine provides significant advantages by directly aligning assessment criteria with the specific goals and content of an assignment, as well as the diverse abilities of the population being assessed. Tailored rubrics provide clear, precise feedback that is relevant to the task at hand, helping those being assessed to understand exactly what is expected and where they can improve. This specificity not only supports more accurate grading but also enhances the learning process by guiding individuals toward the skills and knowledge they need to develop. Additionally, by customizing the rubric to a particular audience (e.g., a particular grade level of students), the rubric engine generates rubrics that account for the diverse needs and abilities of different populations, ensuring that the assessment is fair and meaningful for all learners. By creating customized rubrics, the rubric engine fosters a more engaging and effective educational experience, where learners are more likely to achieve the intended educational outcomes.

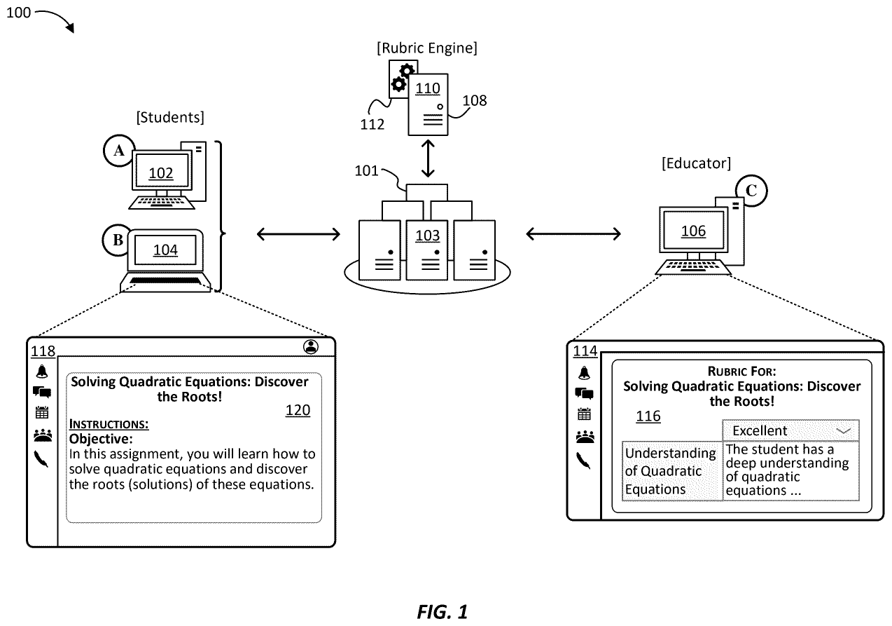

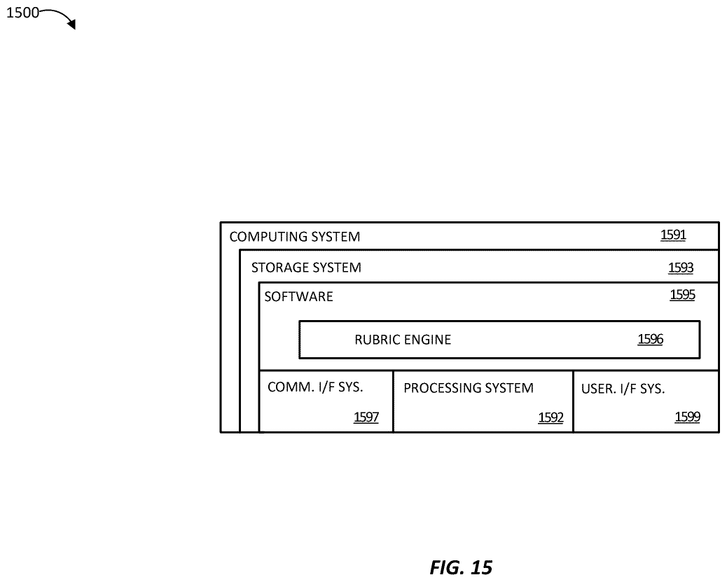

Turning now to FIG. 1, FIG. 1 illustrates an operational environment 100 providing a rubric engine that generates customized rubrics tailored to an assignment, and in some cases the assessed population, according to an embodiment herein. As illustrated, the operational environment 100 includes an application service 101, a rubric engine 108, and client devices 102, 104, and 106. The application service 101 employs one or more server computers 103 co-located with respect to each other or distributed across one or more data centers. Example servers include web servers, application servers, virtual or physical servers, or any combination or variation thereof, of which computing system 1501 in FIG. 15 is broadly representative.

The client devices 102, 104, and 106 communicate with application service 101 via one or more internets and intranets, the Internet, wired and wireless networks, local area networks (LANs), wide area networks (WANs), or any other type of network or combination thereof. Examples of the client devices 102, 104, and 106 may include personal computers, tablet computers, mobile phones, gaming consoles, wearable devices, Internet of Things (IOT) devices, and any other suitable devices, of which computing system 1501 in FIG. 15 is also broadly representative.

Broadly speaking, the application service 101 provides software application services to end points, such as the client devices 102, 104, and 106, examples of which include productivity software for creating content (e.g., word processing, spreadsheets, and presentations), email software, and collaboration software. The client devices 102, 104, and 106 load and execute software applications locally that interface with services and resources provided by the application service 101. The applications may be natively installed and executed applications, web-based applications that execute in the context of a local browser application, mobile applications, streaming applications, or any other suitable type of application. Example services and resources provided by the application service 101 include front-end servers, application servers, content storage services, authorization and authentication services, and the like.

The application service 101 also includes an integration with the rubric engine 108, which is capable of generating a rubric for assessing performance of users of the client devices 102 and 104 on a respective assignment or task. As will be described in greater detail below, one or more of the client devices 102 and 104 may be assigned an assignment or task by the client device 106, via the application service 101. For example, the application service 101 may provide an educational application or platform through which assignments are assigned by a user of the client device 106, which may be an educator, to users of the client devices 102 and 104, which may be students. During creation and/or delegation of the assignment, the user of the client device 106 may leverage the rubric engine 108 and one or more of its functions to generate a rubric that is tailored to the assignment and/or the students associated with the client devices 102 and 104.

To provide these functions, the rubric engine 108 employs one or more server computers 110 co-located with respect to each other or distributed across one or more data centers, of which computing system 1501 in FIG. 15 is broadly representative. In some embodiments, the rubric engine 108 hosts a content generator 112 on server computers 110 as well. In other embodiments, the content generator 112 may be hosted separately from the rubric engine 108, such as by a third party. As will be described in greater detail below, the rubric engine 108 may be in operable communication with the content generator 112, such as a large language model (LLM), to generate one or more features of a respective rubric.

The application service 101 hosts or provides an application, such as an educational application, through which users of the client devices 102 and 104, user A and user B, respectively, can complete an assignment or task, such as assignment 120. For example, the application service 101 may provide or host an educational application through which exercises or assignments 120 are prepared by an educator, such as the user of the client device 106 (user C). Users A and B may be students in the illustrated example. As such, users A and B may perform and complete one or more assignments 120 via the user interface 118 provided by the application service 101 through a corresponding educational application. As used herein, an assignment may be a task or activity given to one or more individuals by an educational leader, such as a teacher, that is designed to assess the individuals understanding, skills, and application of knowledge in a particular subject or topic. The assignment may serve as a tool for both learning and evaluation, helping to reinforce concepts and gauge an individual's progress.

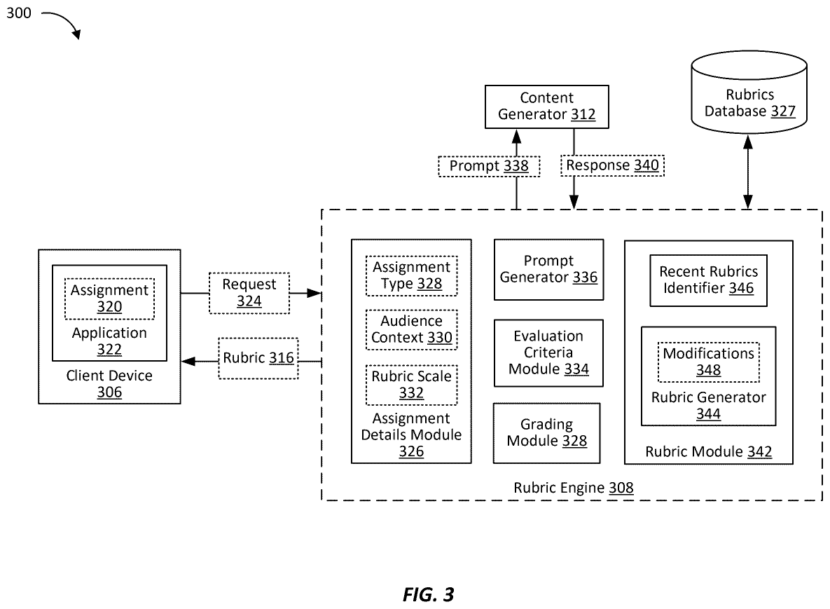

To provide tailored assessment of the assignment 120, the user C of the client device 106 may generate a rubric, such as the rubric 116. In particular, the user C may leverage the rubric engine 108 to generate the rubric 116 that is tailored to the assignment 120, and in some cases the assessed population, which includes the users A and B. As illustrated, the user C may interface with the application service 101, and thus the rubric engine 108, via a user interface 114 to generate the rubric 116. As will be described in greater detail below with respect to FIGS. 3-14, the user C may customize various features of the rubric 116 to ensure that it provides assessments that accurately reflect and appreciate the content of the assignment as well as the abilities of the assessed population (e.g., the users A and B).

The rubric 116 may include one or more evaluation criteria for assessing the work product or performance on a task assigned to the users A and B. As can be appreciated, the evaluation criteria may vary depending on the type of assignment 120 and the context of the assignment 120. For example, a book project may require different evaluation criteria than a laboratory experiment. It should be appreciated that while the rubric 116 described herein is a matrix with two key dimensions: a scale along one axis and evaluation criteria along the other, other rubric formats are contemplated. In general, the rubric 116 provided herein may provide one or more assessments across a range of evaluation criteria, as described in greater detail below. In some cases, the rubric 116 may include a scale that is tailored to the capabilities of the assessed population and the topic being covered.

In some embodiments, the rubric engine 108 may also aid the user C in evaluating or grading a completed assignment. For example, upon completion of the assignment 120, the client device 106 may receive the completed assignment as well as the rubric 116 associated with the assignment. To evaluate the completed assignment, the user C may select respective assessments on the rubric 116 to reflect the quality of work product in the completed assignment, which may be received by the rubric engine 108. Responsive to receiving the selections, the rubric engine 108 may generate an overall assessment or grade for the completed assignment. Such examples will be described in greater detail below.

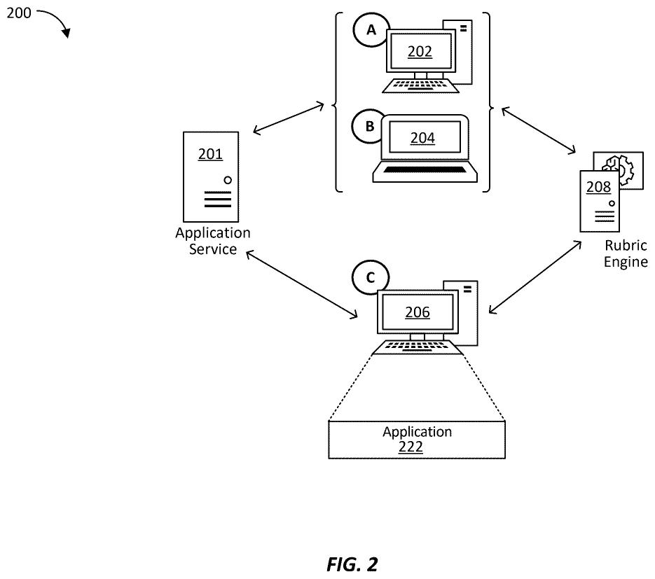

Turning now to FIG. 2, FIG. 2 illustrates a brief operational scenario 200 to further highlight an application of the rubric engine, according to an embodiment provided herein. As shown, in operational scenario 200, there are two assessed users (e.g., students), users A and B, and an assessing user (e.g., educator), user C. Users A and B may operate the client devices 202 and 204, respectively, which may be the same or similar to the client devices 102 and 104 described above with respect to FIG. 1. Similarly, user C may operate the client device 206, which may be the same or similar to the client device 106.

As illustrated, the user C of the client device 206 may open an application, such as an educational application 222 (e.g., an education-based collaboration application), to create and/or assign an assignment, such as the assignment 120. To open the application 222, the client device 206 may communicate with an application service 201, which may be the same or similar to the application service 101. The application service 201 may initiate and operate the educational application 222 on the client device 206. Once the application is open on the client device 206, the user C may begin creating the assignment 120 within the educational application 222 by, for example, selecting a type and providing assignment instructions.

As noted above, the educational application 222 allows for generation of enhanced and customized rubrics as generated by rubric engine 208. The rubric engine 208 may be the same or similar to the rubric engine 108. As such, in some embodiments, upon initiating the educational application 222 on the client device 206, software corresponding to the rubric engine 208 may also be initiated. That is, settings associated with the educational application 222 may provide the option to the client device 206 for creating a rubric before, after, and/or during development of a respective assignment. For example, if user C is an educator, as the user C generates an assignment for the users A and B, the educational application 222 may provide an option to generate a rubric for the assignment. If the user C selects the option to generate the rubric, the application 222, via the application service 201 may interact with the rubric engine 208 to generate the rubric. In some cases, once the rubric is generated, rubric engine 208 may provide the rubric to the client devices 202 and 204 along with the assignment so that the users A and B are provided with the criteria that they will be evaluated on for the assignment.

Turning now to FIG. 3, a system 300 for providing a rubric engine 308 is illustrated, according to an embodiment herein. The system 300 includes the rubric engine 308 and a client device 306, which may be the same or similar to the rubric engine 108 and the client device 106, respectively. In the illustrated example, the rubric engine 308 provides customizable rubrics that are tailored to assignments and/or the assessed population. For ease of discussion the user of the client device 306 is described as an educator within an educational environment, however, it should be appreciated that other scenarios are also contemplated, such as an individual using the rubric engine 308 in a personal capacity to assess progress on mastering a skill or subject matter.

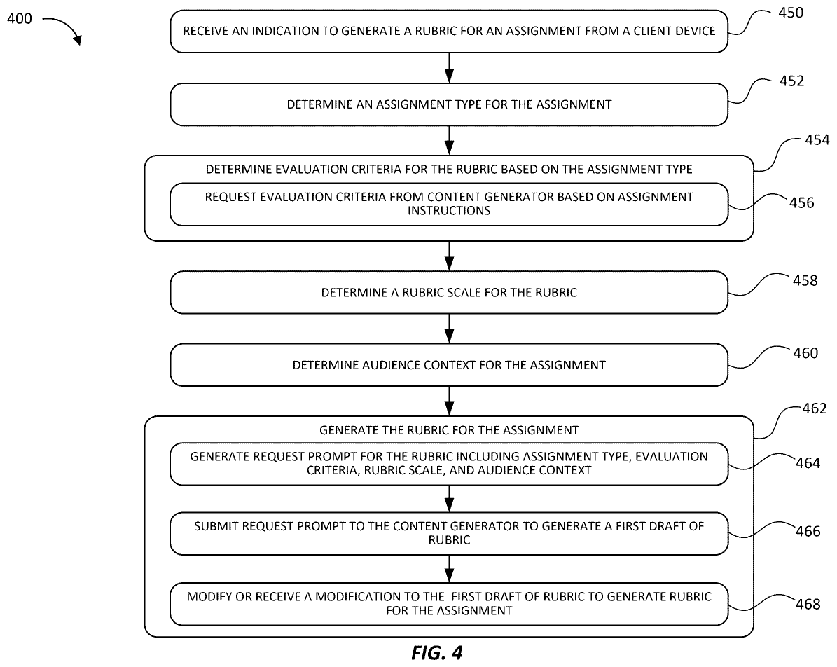

For ease of explanation, FIG. 3 is described in combination with FIGS. 4-14. As such, the following discussion may refer to various figures in turn. For example, FIG. 3 is described with relation to FIG. 4 which provides a process 400 for providing the rubric engine 308 and its related functions, such as for generating a customized rubric for an assignment, according to an embodiment herein. The process 400 may also be referred to herein as the rubric engine process 400. Although the process 400 is described with respect to components and elements of FIG. 3, it should be appreciated the one or more steps of the process 400 may be executed or applied to components or elements of any other Figure provided herein.

As illustrated, the user of client device 306 may begin creating an assignment for completion by one or more individuals (not shown). For example, the user of the client device 306 may open an educational application 322, to begin creating an assignment 320. During creation of the assignment 320 or as part of generating the assignment 320, the user of the client device 306 may indicate to generate a corresponding rubric 316 for the assignment 320. In such a case, the rubric engine 308 may receive an indication to generate the rubric 316 for the assignment 320 from the client device 306 (450). For example, the rubric engine 308 may receive a request 324 to generate the rubric 316 based on the assignment 320 from the client device 306.

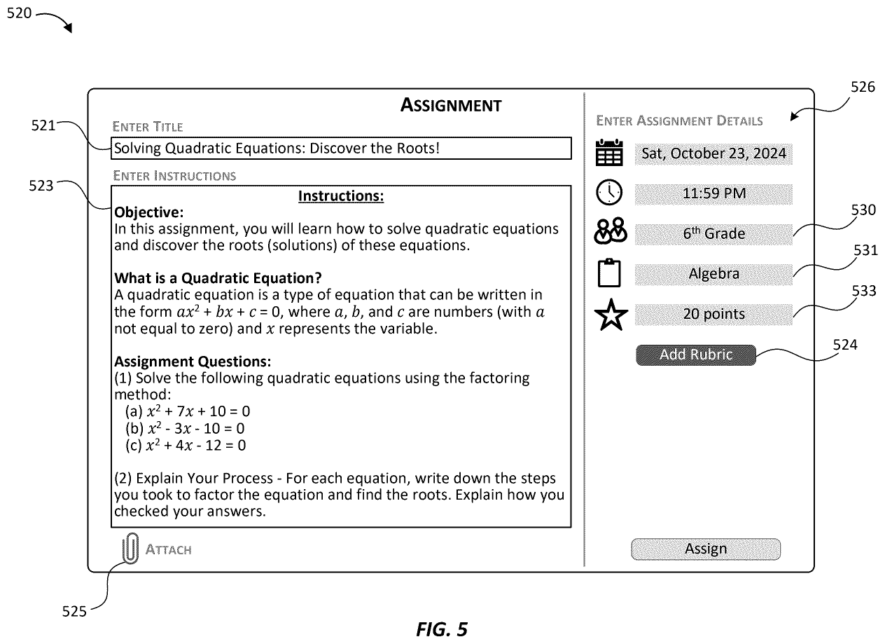

Referring now to FIG. 5, an example assignment prompt 520 is illustrated, according to an embodiment herein. The assignment prompt 520 may be part of a graphical user interface (GUI) provided via the client device 306 to an educator for generating the assignment 320. As shown, the assignment prompt 520 includes an input field for an assignment title 521, into which the educator can input a desired title for the assignment 320. Here, the assignment title 521 is “Solving Quadratic Equations: Discover the Roots!” The assignment prompt 520 also includes assignment instructions 523 into which the educator can provide instructions for the assignment 320. As illustrated, the assignment instructions 523 include an objective for the assignment as well as questions to be completed for the assignment 320. In some cases, the assignment instructions 523 may include one or more attachments 525. For example, if the assignment 320 is a reading assignment, the assignment instructions 523 may include an attachment 525 that includes the reading material for the assignment 320.

The assignment prompt 520 also includes assignment details 526 which allow the educator to specify various parameters for the assignment 320. As illustrated, the assignment details 526 may include date and time fields as well as options to provide context for the assignment 320. Context for the assignment 320 may include a grade, academic, and/or age level 530 for the population being assessed, which is also referred to herein as audience context. As can be appreciated, identifying the grade, academic, and/or age level 530 for the assignment 320 may be advantageous because it can allow the assignment 320 to be appropriately challenging, engaging, and accessible to the assessed population (e.g., students). That is, by selecting the level 530, the assignment 320 can be adapted to the assessed population's developmental stage(s) and cognitive abilities, leading to more effective skill development and knowledge retention. As will be described in greater detail below, the level 530 may be used by the rubric engine 308 to tailor the rubric to the skills and cognitive abilities of the assessed population.

The assignment details 526 may also include an assignment topic and/or type 531 and a points amount 533 for the assignment. Here, the educator may select the assignment topic or type 531 to be for algebra and assign the 20 points to the assignment 320. It should be appreciated that the assignment details 526 may include other information for the assignment 320, however, for the sake of brevity and ease of illustration, only the above mentioned elements are provided.

In addition to the assignment details 526, the assignment prompt 520 may also include add rubric option 524. The add rubric option 524 may allow the educator to generate a rubric corresponding to the assignment 320. Upon selection of the option 524, the rubric engine 308 may generate the rubric 316 for the assignment 320 as described in greater detail below. For example, upon selection of the option 524, the rubric engine 308 may receive the request 324 from the client device 306 and initiate generation of the rubric 316.

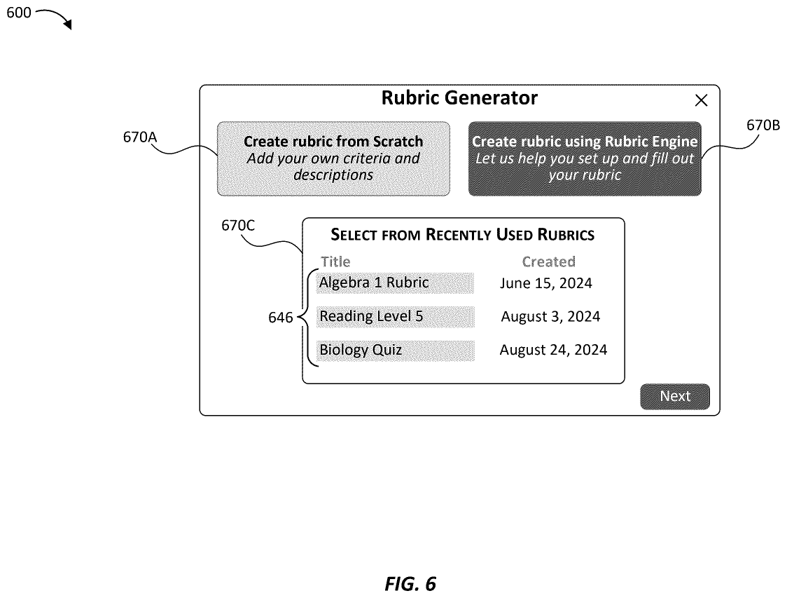

Upon receipt of the request 324, the rubric engine 308 may provide the client device 306 with various options to generate the rubric 316. Referring now to FIG. 6, an example prompt 600 providing options 670A-C for generating the rubric 316 is illustrated, according to an embodiment herein. The prompt 600 may be provided to the client device 306 via the user interface 114 and allow the educator to select between an option 670A to create a rubric manually or an option 670B to create a rubric using the rubric engine 308. The prompt 600 may also include an option 670C to select from one or more recent rubrics 646.

In some embodiments, the rubric engine 308 may identify one or more recent rubrics 646 responsive to receiving the request 324. With reference to FIG. 3, the rubric engine 308 may include a rubric module 342 that includes a recent rubrics identifier 346. The recent rubrics identifier 346 may determine the recent rubrics 646 for the client device 306. For example, the recent rubrics identifier 346 may determine the recent rubrics 646 based on the client device 306, such as a user profile associated with the client device 306. As can be appreciated, educators often teach the same subject matter to different classes over the years. As such, the educator associated with the client device 306 may desire to reuse or modify a recently used rubric for the assignment 320. As such, the recent rubrics identifier 346 may query a rubric database 327 associated with the rubric engine 308 to identify the one or more recent rubrics 646. As will be described in greater detail below, when a rubric, such as the rubric 316 is generated, the rubric engine 308 may save or store the rubric 316 in the rubric database 327 so that the client device 306 can access and/or use the rubric 316 at a later time.

Although the recent rubric identifier 346 is described as identifying recent rubrics 646 based on the “recency” of use or generation of a respective rubric, it should be appreciated that the recent rubrics 646 may be or include similar rubrics that are identified based on other factors. These factors may be include similarity to the topic of a respective assignment, assignment type, grade, academic and/or age level, or most frequently used rubrics.

To generate the rubric 316 the client device 306 may select one of the options 670A-C. As can be appreciated, if the user of the client device 306 selects the option 670A, the rubric engine 308 may provide a template that allows the educator to manually fill in the rubric 316. And if the user of the client device 306 selects one of the recent rubrics 646 from the option 670C, the rubric engine 308 may identify and fetch the respective rubric 646 from the rubric database 327 and provide that rubric to the client device 306 for modification. However, if the client device 306 selects the option 670B to generate a rubric using the rubric engine 308, the rubric engine 308 may generate the rubric 316 based on the assignment 320, as described below. For the following discussion, the illustrative example may be based on the client device 306 selecting the option 670B.

Returning to FIG. 3, responsive to selection of the option 670B, and thus the request 324, the rubric engine 308 may determine an assignment type for the assignment 320 (452). In particular, the rubric engine 308 may include an assignment details module 326. The assignment details module 326 may determine various details about the assignment 320 for generation of the rubric 316, including an assignment type 331. To determine the assignment type 331, the rubric engine 308 may analyze an assignment prompt associated with the assignment 320, such as the assignment prompt 520. For example, the rubric engine 308 may identify the assignment type 331 as the assignment type 531 specified by the educator in the assignment details 526 on the assignment prompt 520.

In other embodiments, to determine the assignment type 331, the rubric engine 308 may analyze the assignment instructions associated with the assignment 320, such as the assignment instructions 523. For example, as illustrated the rubric engine 308 may be in operational communication with a content generator 312, which may be the same or similar to the content generator 112. As such, in some embodiments, to determine the assignment type 331, the rubric engine 308 may submit the assignment instructions 523 to the content generator 312 via a prompt 338 generated by a prompt generator 336, requesting that an assignment type based on the assignment instructions 523. The content generator 312 may generate a response 340 that identifies the assignment type 331 based on the assignment instructions 523 submitted in the prompt 338.

It should be appreciated that while the prompt 338 is illustrated as a single prompt and referred to repeatedly in the below discussion, the prompt 338 is illustrative of one or more prompts. Each reference to the prompt 338 below may be to an individual or separate prompt corresponding to the context of the description. Similarly, the response 340 may be representative of one or more responses generated by the content generator 312 and reference to the response 340 may indicate a separate response based on the context of the surrounding description.

Additionally, while the content generator 312 is illustrated as separate from the rubric engine 308, in some embodiments the content generator 312 may be hosted by the application service 101 and/or a third party. In some embodiments the content generator 312 may be a text-to-text generative model, such as an LLM, or may be a text-to-image generative model or a multimodal (e.g., text and images) generative model. Examples include generative pre-trained transformer models. Although only one content generator 312 is illustrated, it should be appreciated that the rubric engine 308 may include more than one content generator 312, including different types of content generators 312.

The rubric engine 308 may determine evaluation criteria for the assignment 320 (454), in some cases, based on the assignment type 331. The evaluation criteria may include standards or benchmarks used to assess and measure the quality or effectiveness of an assessed individual's performance on the assignment 320. The evaluation criteria may also provide clear expectations for the work product and/or performance on the assignment 320 to help ensure consistent and objective grading. To determine the evaluation criteria for the assignment 320, the rubric engine 308 may include an evaluation criteria module 334. The evaluation criteria module 334 may determine evaluation criteria for the rubric 316.

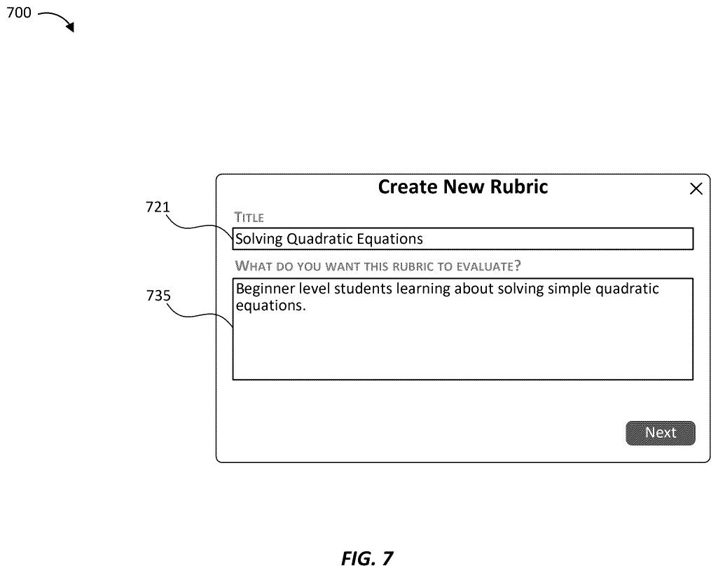

Referring now to FIG. 7, an example prompt 700 for creating a rubric is illustrated, according to an embodiment herein. The prompt 700 may be provided to the client device 306 by the rubric engine 308 responsive to selection of the option 670B to generate a new rubric. As shown, the prompt 700 includes a rubric title 721 and a rubric description 735. In some embodiments, the rubric engine 308 may populate the rubric title 721 based on the assignment title 521, while in other embodiments the educator may input the rubric title 721. For the rubric description 735, the user of the client device 306 may input a brief description of what the rubric is going to evaluate. When the rubric 316 is saved after generation, the rubric description 735 may provide context to the rubric 316 for users at a later time.

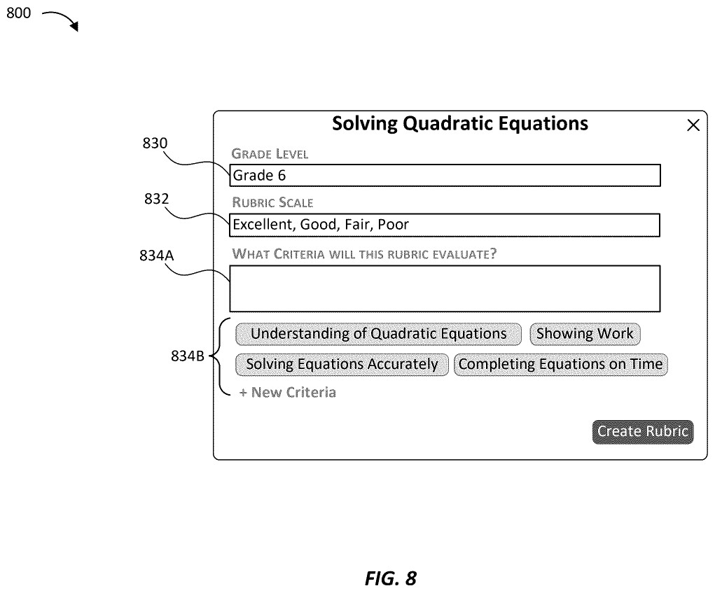

Referring now to FIG. 8, another example prompt 800 for creating a rubric is illustrated, according to an embodiment herein. The prompt 800 may be provided to the client device 306 subsequent to the prompt 700 or in place of the prompt 700 to allow the educator to further define criteria for the rubric 316. As illustrated, the prompt 800 allows the educator to define a grade, academic, or age level 830, a rubric scale 832, and evaluation criteria 834A-B for the rubric 316. In some embodiments, the rubric engine 308 may populate the level 830 based on the level 530, while in other embodiments, the educator may input a desired selection. The educator may also define a rubric scale 832 for the assignment 320. The rubric scale 832 may be a range of levels or points within the rubric 316 that indicates the degree of proficiency or quality of an individual's work. That is, the rubric scale 832 provides a structured way to rate performance across different criteria, from high to low or excellent to poor.

As illustrated, the prompt 800 allows the educator to define evaluation criteria 834A-B for the assignment 320. For example, the prompt 800 may include an input field into which the educator can manually define evaluation criteria 834A. The prompt 800 also includes evaluation criteria 834B generated by the rubric engine 308. To generate the evaluation criteria 834B, the evaluation criteria module 334 may request the evaluation criteria from the content generator 312 based on the assignment instructions (456). For example, the evaluation criteria module 334 may coordinate with the prompt generator 336 to generate the prompt 338. The prompt 338 may include the assignment instructions 523 and request evaluation criteria for an assignment based on the assignment instructions 523. In embodiments where the assignment instructions 523 include an attachment 525, the prompt 338 may include the attachment 525 as well.

Once generated, the evaluation criteria module 334 may submit the prompt 338 to the content generator 312. Responsive to receiving the prompt 338, the content generator 312 may generate the response 340 containing the evaluation criteria 834B. The evaluation criteria module 334 may detect the individual evaluation criteria 834B from the response 340 and provide them via the prompt 800 to the client device 306. The educator, via the client device 306 may select one or more of the evaluation criteria 834B, as well as manually define one or more additional evaluation criteria 834A for the rubric 316.

In addition to determining the evaluation criteria 834A-B, the rubric engine 308 may also determine additional context for the rubric. For example, in some embodiments, the rubric engine 308 may determine a rubric scale 332 for the rubric (458), such as identifying the rubric scale 832 defined by the educator via the prompt 800. Additionally, the rubric engine 308 may determine an audience context 330 for the assignment (460), such as identifying the grade, academic, or age level 830 defined by the educator via the prompt 800.

Once the evaluation criteria 834A-B are determined, the rubric engine 308 may generate the rubric 316 for the assignment 320 (462). To generate the rubric 316, the rubric module 342 may include a rubric generator 344. The rubric generator 344 may coordinate with the prompt generator 336 to generate the prompt 338 requesting generation of the rubric 316 (464). The prompt 338 may be or include a request to generate the rubric 316 based on the evaluation criteria 834A-B, and in some embodiments, one or more of the assignment type 331, the audience context 330, and the rubric scale 332. In some embodiments, prompt 338 may include the assignment instructions 523 to provide further context to the content generator 312. The rubric generator 344 may submit the prompt 338 to the content generator 312 which may responsively generate the response 340 (466). The response 340 may include a first draft of the rubric 316. Upon generation, the rubric engine 308 may provide the first draft of the rubric 316 to the client device 306.

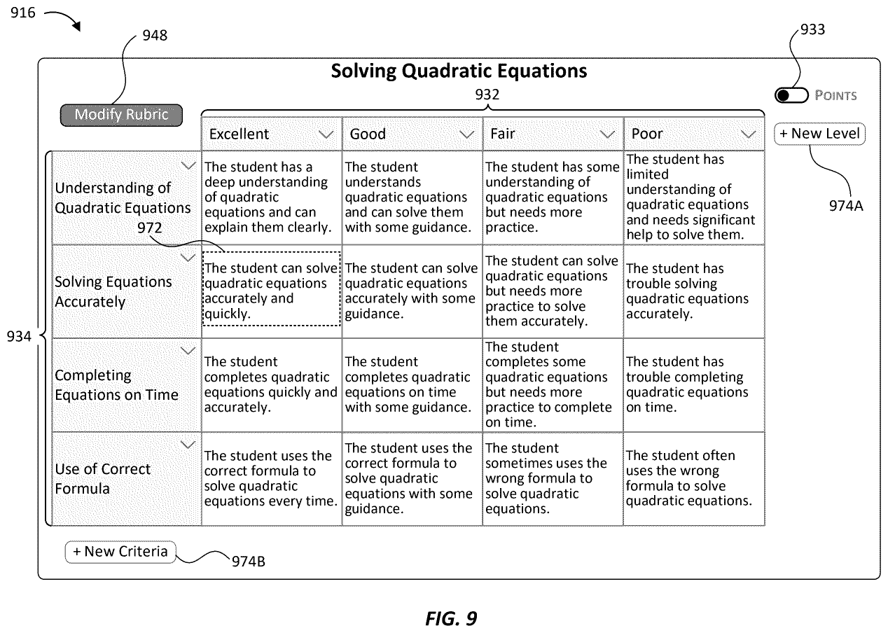

Referring now to FIG. 9, an example rubric 916 generated by the rubric engine 308 is illustrated, according to an embodiment herein. As illustrated, the rubric 916 contains two dimensions, a rubric scale 932 along one axis and evaluation criteria 934 along the other axis. At the intersection of each evaluation criteria and scale factor, an assessment 972 is provided defining the degree of proficiency of quality of performance needed to meet the respective scale factor. As noted above, the rubric 916 may be a first draft of the rubric 316, and as such may allow the educator to modify the rubric 916 (468).

As illustrated, various options 974A and 974B may allow modification of the rubric scale 932 and the evaluation criteria 934, respectively. For example, upon selection of the option 974A, the educator can add another scale factor to the rubric scale 932, such as defining another level to the rubric scale 932. Similarly, the educator may select the option 974B to add another criteria to the evaluation criteria 934, such as another property or skill the rubric 916 should define or analyze. The educator can also modify the assessment 972 along each intersection by selecting a desired assessment 972. Upon selection of a respective assessment 972, the educator can manually edit the text or request the rubric engine 308 regenerate that particular assessment.

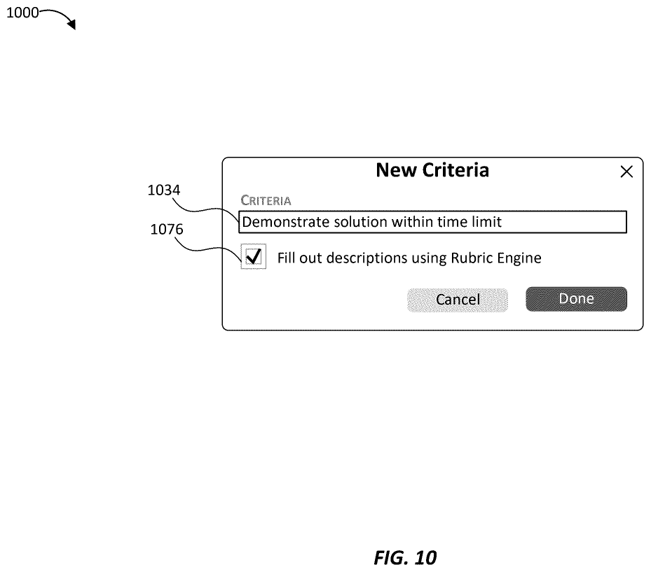

Referring now to FIG. 10, an example prompt 1000 for defining new criteria to be added to a draft rubric is illustrated, according to an embodiment herein. For example, upon selection of the option 974B, the prompt 1000 may be generated and provided for display on the client device 306. As shown, the prompt 1000 allows the educator to define a name of the new evaluation criteria 1034 and a selection 1076 that indicates that the rubric engine 308 should define the assessments for the new criteria 1034. If the selection 1076 is selected, the rubric engine 308 may generate, via the content generator 312, the assessments for the new criteria 1034 across the rubric scale 932. It should be appreciated that a similar prompt (not shown) may be provided upon selection of the option 974A to add a new scale factor to the rubric scale 932, in which the user can define the new scale factor.

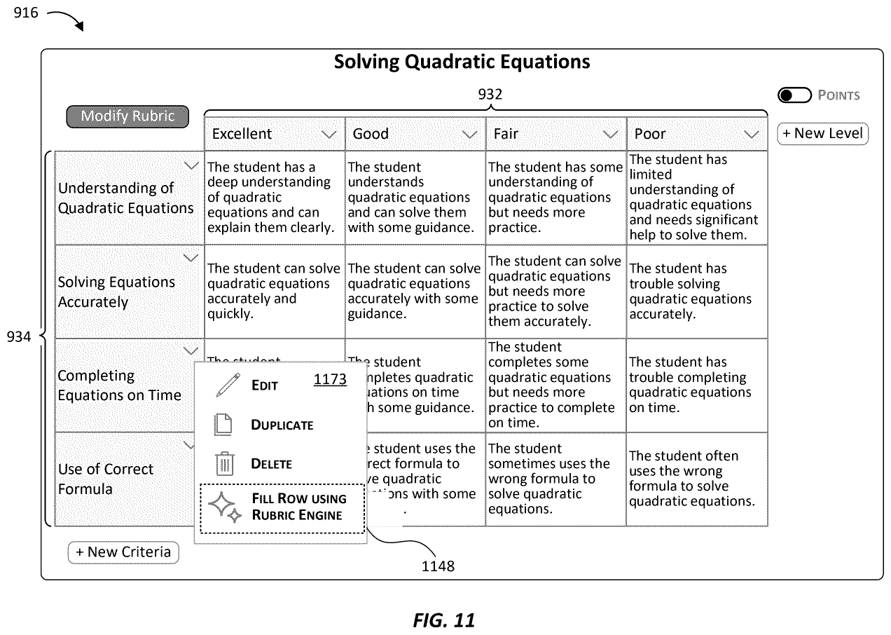

Referring now to FIG. 11, example modification options for the rubric 916 are illustrated, according to an embodiment herein. That is, in some embodiments, upon selection of a respective evaluation criteria 934, options 1173 may be provided to the educator. The options 1173 may allow the educator to modify a particular evaluation criteria 934 across the rubric scale 932, such as deleting the respective criteria from the evaluation criteria 934 or manually editing the respective assessments. The options 1173 may also provide the option 1148 to regenerate the assessments for the criteria across the rubric scale 932. Upon selection of the option 1148, the rubric engine 308 may regenerate the assessments for the respective criteria across the rubric scale 932, as described below in greater detail.

Returning to FIG. 9, the illustrated example also includes a modify rubric option 948. In addition to the modifications described above, the educator may select the option 948 to modify the rubric 916 comprehensively. Upon selection of the option 948, the rubric engine 308 may modify the entire rubric 916, such as updating the assessments 972 for each of the evaluation criteria 934 across the rubric scale 932.

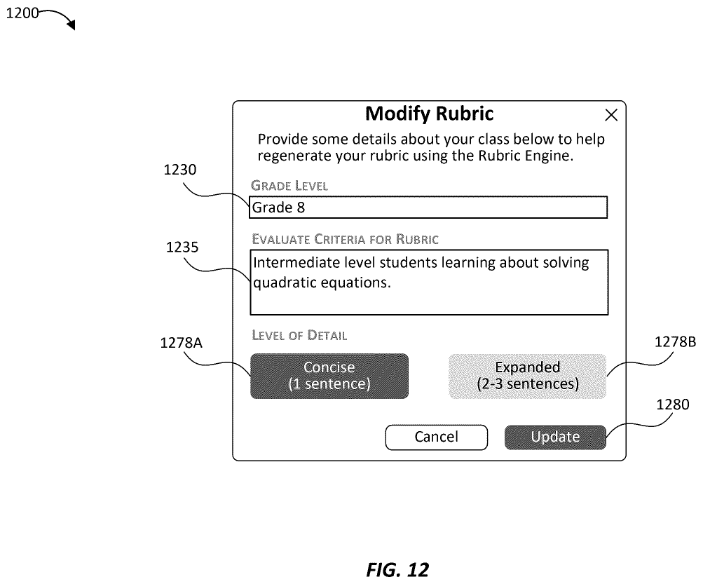

Referring now to FIG. 12, an example prompt 1200 for modifying a rubric is illustrated, according to an embodiment herein. The prompt 1200 may be generated and provided to the client device 306 by the rubric engine 308 responsive to the educator selecting the option 948. As shown, the prompt 1200 may allow the educator to modify various details for the rubric, such as modifying a grade level 1230 for the rubric. As can be appreciated, modifying the grade level 1230 (or grade, academic, or age level 830) may modify the audience context 330 of the rubric 316/916. Changing the audience context 330 may cause the rubric engine 308 to modify the evaluation criteria, or in some cases, the assessments 972 within the rubric 916.

The prompt 1200 may also include an input field into which the educator can enter modified rubric description 1235 for the modified rubric. Here, the educator entered the modified rubric description 1235 of “intermediate level students learning about solving quadratic equations.” This may have updated the original rubric description 735 which indicated the rubric was for beginning level students. In some embodiments, the rubric engine 308 may use the rubric description 1235 (and 735) to generate the evaluation criteria 934, as well as the assessments 972 provided therein.

In some embodiments, the prompt 1200 may allow the educator to modify the detail level of the assessments 972 within the rubric. As illustrated, options 1278A-B may allow the educator to select between the assessments 972 being concise, thus consisting of 1 sentence, or the assessments 972 being expanded, thus containing 2-3 sentences. As can be appreciated, other variations in detail level of the assessments 972 may be provided via the options 1278A-B. Once the educator makes any desired changes via the prompt 1200, the educator may select the update option 1280.

Returning to FIG. 3, the rubric engine 308 may receive any modifications 348 made with respect to the draft rubric 916. In particular, the rubric generator 344 may receive the modifications 348 as indicated by the prompts 1000 or 1200, or by selection of the options 948 or 1148. Responsive to receiving the modifications 348, the rubric generator 344 may submit the draft rubric 916 or relevant portions therein, along with the modifications 348 to the content generator 312. The content generator 312 may update or modify the draft rubric 916 based on the modifications 348, thereby generating a subsequent draft or final rubric 316. In some embodiments, the rubric engine 308 may save each draft or version of a rubric as it is modified to allow the educator to view the changes made over time. In some embodiments, the educator may be able to scroll or switch between different versions of the rubric 316 to return to a prior version.

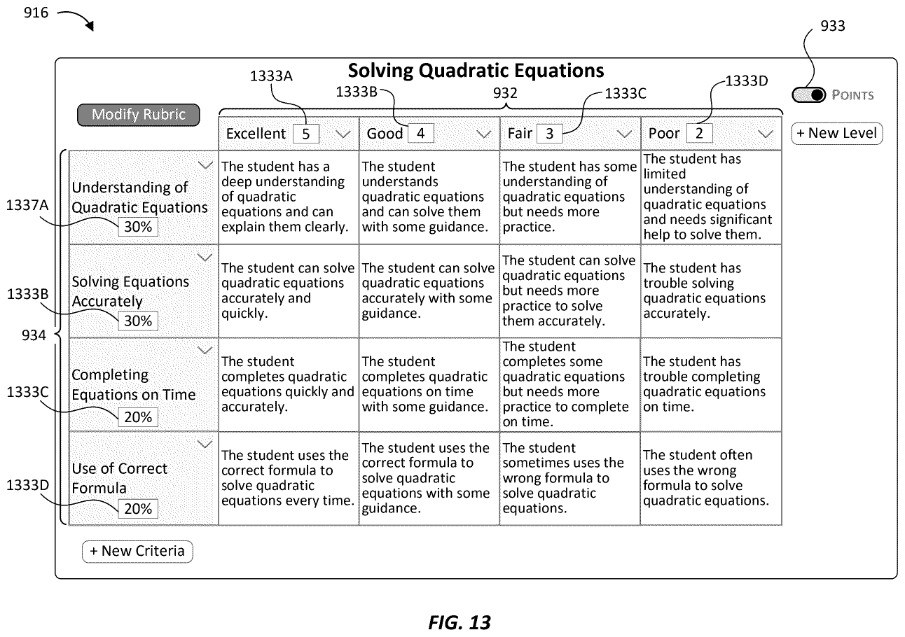

Referring now to FIG. 13, the rubric 916 containing point values is illustrated, according to an embodiment herein. In some embodiments, the rubric engine 308 may generate and add point values 1333A-D and weights 1337A-D to the rubric scale 932 and the evaluation criteria 934, respectively. For example, the rubric 916 may include a points option 933 which, upon selection, causes the rubric engine 308 to generate and assign the point values 1333A-D and/or weights 1337A-D to the rubric 916. As noted above, the educator may define a point amount 533 for a respective assignment. Based on the point amount 533 and the rubric scale 932, the rubric generator 344 may determine point values 1333A-D for each of the scale factors across the rubric scale 932. The rubric engine 308 may also determine weights 1337A-D for each of the evaluation criteria 934. In some embodiments, the rubric engine 308 may determine a respective weight 1337A-D based on the content of the evaluation criteria. For example, the criteria for solving equations accurately may be assigned a higher weight 1333B than completing the weight 1333C for completing equations on time. In other embodiments, the educator may define each of the weights 1337A-D.

As noted above, once the rubric 916 is completed as desired by the educator, the educator may indicate to associate the rubric 316 (which represents a final draft of the rubric 916) with the assignment 320. In some embodiments, responsive to determining that the rubric 916 is in final form and completed, the rubric engine 308 may save the rubric 316 to the rubric database 327. When stored, the rubric 316 may be associated with the client device 306 which generated and/or created the assignment 320. This may allow the educator to reuse the rubric 316 for future assignments and/or classes. In some embodiments, the rubric database 327 may be a shared database that allows for other educators to view, access, and/or use the rubric 316.

In some embodiments, the rubric engine 308 may assist the educator in grading the assignment 320 as it is completed. For example, when a student completes the assignment 320, a grading module 328 within the rubric engine 308 may determine that the rubric 316 is associated with the assignment 320 and provide the rubric 316 to the client device 306, in some cases, along with the completed assignment 320. The rubric 316 may be provided to the client device 306 in such a format that the educator can make selections on the rubric 316 to assess the work product and performance of the student on the assignment 320.

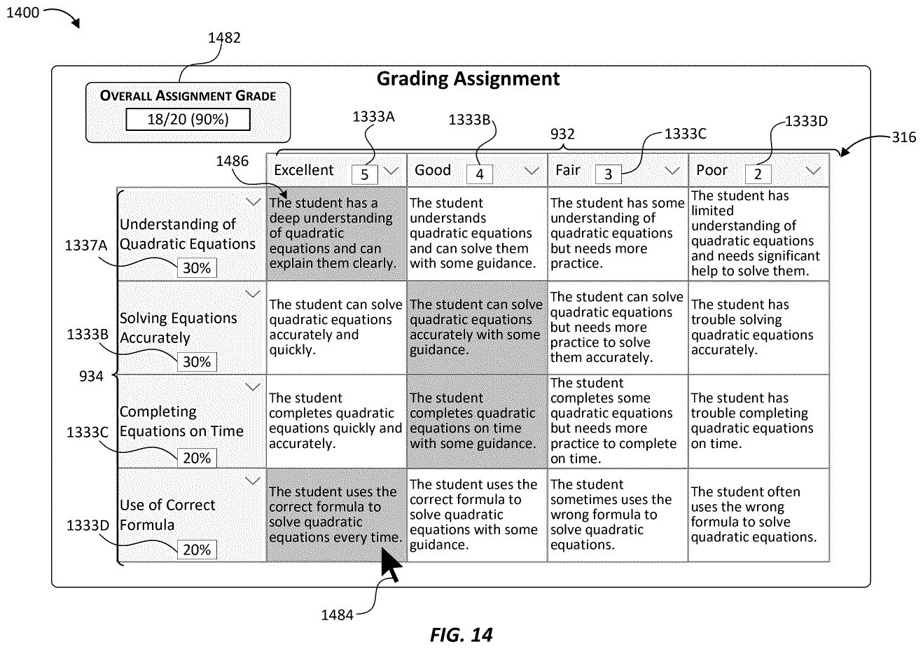

Referring now to FIG. 14, an example grading assignment 1400 including the rubric 316 is illustrated, according to an embodiment herein. As the educator reviews the completed assignment 320, the educator may select various assessments that match the student's performance and work product. For example, the educator may use a cursor 1484 to make the selections 1486 indicated in dark grey for a particular scale factor across each of the evaluation criteria 934. As shown, the educator may select the excellent scale factor for the first and fourth evaluation criteria 934 and the good scale factor for the second and third evaluation criteria, as indicated by the greyed-out assessments 1486.

Based on the selections 1486, the grading module 328 may generate an overall assignment grade 1482 or overall assessment value for the assignment 320. The overall assignment grade 1482 may be based on the corresponding point values 1333A-D and weights 1337A-D of the selections 1486. Here, the grading module 328 calculates the overall assignment grade 1482 to be 90% based on the selections 1486. The rubric engine 308 may generate and provide the overall assignment grade 1482 to the client device 306, upon which the user of the client device 306 may modify or submit as a final grade.

Referring to FIG. 15, FIG. 15 illustrates a computing system 1591 that may be used for providing a rubric engine and related functions, as described herein. For example, the client devices 102, 104, or 106 may be or include the computing system 1591. As illustrated, the computing system 1591 includes a processing system 1592 that includes a microprocessor and other circuitry that retrieves and executes software 1595 from storage system 1593. The processing system 1592 may be implemented within a single processing device but may also be distributed across multiple processing devices or sub-systems that cooperate in executing program instructions. Examples of the processing system 1592 include general purpose central processing units, graphical processing units, application specific processors, and logic devices, as well as any other type of processing device, combinations, or variations thereof.

The storage system 1593 may comprise any computer readable storage media readable by processing system 1592 and capable of storing software 1595. The storage system 1593 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 1593 may also include computer readable communication media over which at least some of the software 1595 may be communicated internally or externally. The storage system 1593 may be implemented as a single storage device but may also be implemented across multiple storage devices or sub-systems co-located or distributed relative to each other. The storage system 1593 may comprise additional elements, such as a controller capable of communicating with the processing system 1592 or possibly other systems.

The software 1595 (including rubric engine process 1596) may be implemented in program instructions and among other functions may, when executed by the processing system 1592, direct the processing system 1592 to operate as described with respect to the various operational scenarios, sequences, and processes illustrated herein. For example, the software 1595 may include program instructions for implementing a rubric engine and related functions, as described herein. In some embodiments, the software 1595 may cause one or more features of the rubric engine process 1596 to provide or display respective components to a user via a user interface system 1599 inoperable communication with a client device, such as the client device 106.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 1595 may include additional processes, programs, or components, such as operating system software, virtualization software, or other application software. The software 1595 may also comprise firmware or some other form of machine-readable processing instructions executable by the processing system 1592.

In general, the software 1595 may, when loaded into the processing system 1592 and executed, transform a suitable apparatus, system, or device (of which computing system 1591 is representative) overall from a general-purpose computing system into a special-purpose computing system customized to generate features, functionality, and user experiences provided by the rubric engine. Indeed, encoding the software 1595 on the storage system 1593 may transform the physical structure of the storage system 1593. The specific transformation of the physical structure may depend on various factors in different implementations of this description. Examples of such factors may include, but are not limited to, the technology used to implement the storage media of the storage system 1593 and whether the computer-storage media are characterized as primary or secondary storage, as well as other factors.

For example, if the computer readable storage media are implemented as semiconductor-based memory, the software 1595 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1597 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 1591 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a rubric engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: one or more computer readable storage media; one or more processors operatively coupled with the one or more computer readable storage media; and an application comprising program instructions stored on the one or more computer readable storage media that, when executed by the one or more processors, direct a computing system to at least: receive, from a client device, an indication to generate a rubric for an assignment; determine, by a rubric engine, an assignment type for the assignment; determine, by the rubric engine, one or more evaluation criteria for the rubric based on the assignment type; determine, by the rubric engine, a rubric scale for the rubric; determine, by the rubric engine, audience context for the assignment; generate, by the rubric engine, the rubric for the assignment based on the one or more evaluation criteria and the audience context for the assignment, wherein the rubric comprises an assessment for each of the one or more evaluation criteria across the rubric scale; and associate, by the rubric engine, the rubric with the assignment.

Example 2 is the system of any previous or subsequent Example, wherein the program instructions to generate, by the rubric engine, the rubric for the assignment based on the one or more evaluation criteria and the audience context for the assignment cause, when executed by the one or more processors, to further direct the computing system to: generate, by the rubric engine, a request prompt for the rubric, wherein the request prompt comprises the assignment type, the one or more evaluation criteria, the rubric scale, and the audience context; submit, by the rubric engine, the request prompt to a content generator, wherein the content generator generates the rubric responsive to receiving the request prompt; and receive, by the rubric engine, the rubric from the request prompt.

Example 3 is the system of any previous or subsequent Example, wherein the program instructions to determine, by the rubric engine, the one or more evaluation criteria for the rubric based on the assignment type cause, when executed by the one or more processors, to further direct the computing system to: submit, by the rubric engine, a request prompt to a content generator, wherein the request prompt comprises: assignment instructions for the assignment to a content generator; and a request for evaluation criteria based on the assignment instructions; and receive, by the rubric engine, the one or more evaluation criteria for the rubric based on the assignment instructions from the content generator.

Example 4 is the system of any previous or subsequent Example, wherein the program instructions to generate, by the rubric engine, the rubric for the assignment based on the one or more evaluation criteria and the audience context for the assignment cause, when executed by the one or more processors, to further direct the computing system to: generate, by the rubric engine, a first draft rubric based on the one or more evaluation criteria and the audience context for the assignment, wherein the first draft rubric comprises a first set of evaluation criteria across a first rubric scale; receive, by the rubric engine, a modification to a first assessment within the first draft rubric; and generate, by the rubric engine, the rubric comprising the one or more evaluation criteria across the rubric scale based on the first draft rubric and the modification.

Example 5 is the system of any previous or subsequent Example, wherein the program instructions to determine, by the rubric engine, the one or more evaluation criteria for the rubric based on the assignment type cause, when executed by the one or more processors, to further direct the computing system to: generate, by the rubric engine, one or more recommended evaluation criteria; provide, by the rubric engine, the one or more recommended evaluation criteria to the client device; and receive, by the rubric engine, a selection of a first evaluation criteria from the one or more recommended evaluation criteria.

Example 6 is the system of any previous or subsequent Example, wherein the program instructions cause, when executed by the one or more processors, to further direct the computing system to: receive, by the rubric engine, a completed assignment; provide, by the rubric engine, the rubric associated with the completed assignment to the client device; receive, by the rubric engine, selection of one or more assessments for the one or more evaluation criteria from the client device; and generate, by the rubric engine, an overall assessment of the completed assignment.

Example 7 is a method comprising: receiving, from a client device, an indication to generate a rubric for an assignment; determining, by a rubric engine, an assignment type for the assignment; determining, by the rubric engine, one or more evaluation criteria for the rubric based on the assignment type; determining, by the rubric engine, a rubric scale for the rubric; determining, by the rubric engine, audience context for the assignment; generating, by the rubric engine, the rubric for the assignment based on the evaluation criteria and the audience context for the assignment, wherein the rubric comprises an assessment for each of the one or more evaluation criteria across the rubric scale; and associating, by the rubric engine, the rubric with the assignment.

Example 8 is the method of any previous or subsequent Example, wherein generating, by the rubric engine, the rubric for the assignment based on the one or more evaluation criteria and the audience context for the assignment comprises: generating, by the rubric engine, a first draft rubric based on the one or more evaluation criteria and the audience context for the assignment, wherein the first draft rubric comprises a first set of evaluation criteria across a first rubric scale; receiving, by the rubric engine, a modification to at least one of the first set of evaluation criteria or the first rubric scale; and generating, by the rubric engine, the rubric comprising the one or more evaluation criteria across the rubric scale based on the first draft rubric and the modification.

Example 9 is the method of any previous or subsequent Example, wherein generating, by the rubric engine, the rubric for the assignment based on the one or more evaluation criteria and the audience context for the assignment comprises: generating, by the rubric engine, a request prompt for the rubric, wherein the request prompt comprises the assignment type, the one or more evaluation criteria, the rubric scale, and the audience context; submitting, by the rubric engine, the request prompt to a content generator, wherein the content generator generates the rubric responsive to receiving the request prompt; and receiving, by the rubric engine, the rubric from the request prompt.

Example 10 is the method of any previous or subsequent Example, wherein generating, by the rubric engine, the rubric for the assignment based on the one or more evaluation criteria and the audience context for the assignment further comprises: receiving, by the rubric engine, a selection on a level of detail for the assessment for each of the one or more evaluation criteria across the rubric scale; and generating, by the rubric engine, a plurality of assessments based on the selection, wherein each of the plurality of assessments corresponds to a respective evaluation criteria of the one or more evaluation criteria and a respective scale factor on the rubric scale.

Example 11 is the method of any previous or subsequent Example, wherein generating, by the rubric engine, the rubric for the assignment based on the one or more evaluation criteria and the audience context for the assignment further comprises: determining, by the rubric engine, a point-value for each scale factor of the rubric scale; and assigning, by the rubric engine, a respective point-value to each scale factor of the rubric scale within the rubric.

Example 12 is the method of any previous or subsequent Example, wherein determining, by the rubric engine, the one or more evaluation criteria for the rubric comprises: generating, by the rubric engine, a request prompt for generation of the one or more evaluation criteria, wherein the request prompt comprises: assignment instructions for the assignment to a content generator; and a request for evaluation criteria based on the assignment instructions; and submit, by the rubric engine, the request prompt to a content generator, wherein the content generator generates the one or more evaluation criteria for the rubric based on the assignment instructions from the content generator.

Example 13 is the method of any previous or subsequent Example, wherein generating, by the rubric engine, the rubric for the assignment based on the one or more evaluation criteria and the audience context for the assignment further comprises: determining, by the rubric engine, a point-value for each scale factor of the rubric scale; and assigning, by the rubric engine, a respective point-value to each scale factor of the rubric scale within the rubric; and the method further comprises: identifying, by the rubric engine, a completed assignment associated with the rubric; receiving, by the rubric engine, selection of one or more assessments for the one or more evaluation criteria from the client device; determining, by the rubric engine, the point-value associated with each selected assessment; and generating, by the rubric engine, an overall assessment of the completed assignment, wherein the overall assessment comprises an aggregation of the point-values of the selected assessments.

Example 14 is the method of any previous or subsequent Example, wherein the rubric engine comprises a generative artificial intelligence (AI) model.

Example 15 is a computer readable storage media comprising processor-executable instructions configured to cause one or more processors to: receive, from a client device, an indication to generate a rubric for an assignment; determine, by a rubric engine, an assignment type for the assignment; determine, by the rubric engine, one or more evaluation criteria for the rubric based on the assignment type; determine, by the rubric engine, a rubric scale for the rubric; determine, by the rubric engine, audience context for the assignment; generate, by the rubric engine, the rubric for the assignment based on the one or more evaluation criteria and the audience context for the assignment, wherein the rubric comprises an assessment for each of the one or more evaluation criteria across the rubric scale; and associate, by the rubric engine, the rubric with the assignment.

Example 16 is the computer readable storage media of any previous or subsequent Example, wherein the processor-executable instructions to generate, by the rubric engine, the rubric for the assignment based on the one or more evaluation criteria and the audience context for the assignment cause the one or more processors to further execute processor-executable instructions stored in the computer readable storage media to: generate, by the rubric engine, a request prompt for the rubric, wherein the request prompt comprises assignment instructions for the assignment and the audience context; and provide, by the rubric engine, the request prompt to a content generator, wherein the content generator generates the rubric responsive to receiving the request prompt.

Example 17 is the computer readable storage media of any previous or subsequent Example, wherein the processor-executable instructions to generate, by the rubric engine, the rubric for the assignment based on the one or more evaluation criteria and the audience context for the assignment cause the one or more processors to further execute processor-executable instructions stored in the computer readable storage media to: generate, by the rubric engine, a first draft rubric based on the one or more evaluation criteria and the audience context for the assignment, wherein the first draft rubric comprises a first set of evaluation criteria across a first rubric scale; receive, by the rubric engine, an indication to add a new evaluation criteria to the first set of evaluation criteria; generate, by the rubric engine, a plurality of new assessments for the new evaluation criteria across the rubric scale; and generate, by the rubric engine, the rubric based on the first draft rubric and the new evaluation criteria, wherein the one or more evaluation criteria comprise the new evaluation criteria.

Example 18 is the computer readable storage media of any previous or subsequent Example, wherein the processor-executable instructions to determine, by the rubric engine, one or more evaluation criteria for the rubric based on the assignment type cause the one or more processors to further execute processor-executable instructions stored in the computer readable storage media to: generate, by the rubric engine, one or more recommended evaluation criteria; provide, by the rubric engine, the one or more recommended evaluation criteria to the client device; and receive, by the rubric engine, a selection of a first evaluation criteria from the one or more recommended evaluation criteria.

Example 19 is the computer readable storage media of any previous or subsequent Example, wherein the processor-executable instructions cause the one or more processors to further execute processor-executable instructions stored in the computer readable storage media to: responsive to receiving, from the client device, the indication to generate the rubric, determine, by the rubric engine, one or more recent rubrics; and provide, by the rubric engine, the one or more recent rubrics to the client device.

Example 20 is the computer readable storage media of any previous or subsequent Example, wherein the processor-executable instructions cause the one or more processors to further execute processor-executable instructions stored in the computer readable storage media to: save, by the rubric engine, the rubric to a rubric database at a first time; receive, by the rubric engine, an indication to generate a second rubric at a second time; receive, by the rubric engine, a selection of the rubric from the rubric database; modify, by the rubric engine, the rubric based on input from a client device; and generate, by the rubric engine, the second rubric based on the input from the client device.

What is claimed is:

1. A system for generating a rubric using a rubric engine operatively coupled to a generative artificial intelligence (GAI) model, the system comprising:
one or more computer readable storage media;
one or more processors operatively coupled with the one or more computer readable storage media; and
an application comprising program instructions stored on the one or more computer readable storage media that, when executed by the one or more processors, direct a computing system to at least:
receive, from a client device via a graphical user interface (GUI), an indication to generate the rubric for an assignment;
determine, by the rubric engine, an assignment type for the assignment;
determine, by the rubric engine, one or more evaluation criteria for the rubric based on the assignment type;
determine, by the rubric engine, a rubric scale for the rubric;
determine, by the rubric engine, audience context for the assignment;
generate, by the rubric engine, the rubric for the assignment based on the one or more evaluation criteria and the audience context for the assignment, wherein:
the rubric comprises one or more assessments for each of the one or more evaluation criteria across the rubric scale;
the one or more assessments are modifiable by a user via the GUI on the client device; and
generating the rubric for the assignment comprises:
generating, by the rubric engine, a request prompt for the rubric, wherein the request prompt is configured to elicit a response from the GAI model and comprises the assignment type, the one or more evaluation criteria, the rubric scale, and the audience context; and
submitting, by the rubric engine, the request prompt to the GAI model which
generates the rubric responsive to receiving the request prompt;
display, via the GUI on the client device, the rubric in a structured format that adjusts based on the one or more evaluation criteria, the rubric scale, and the one or more assessments; and
associate, by the rubric engine, the rubric with the assignment and a corresponding version history of the rubric.

2. The system of claim 1, wherein the program instructions to generate, by the rubric engine, the rubric for the assignment based on the one or more evaluation criteria and the audience context for the assignment cause, when executed by the one or more processors, to further direct the computing system to:
receive, by the rubric engine, a selection on a level of detail for the one or more assessments for each of the one or more evaluation criteria across the rubric scale; and
generate, by the rubric engine, the one or more assessments based on the selection, wherein each of the one or more assessments corresponds to a respective evaluation criteria of the one or more evaluation criteria and a respective scale factor on the rubric scale.

3. The system of claim 1, wherein the program instructions to determine, by the rubric engine, the one or more evaluation criteria for the rubric based on the assignment type cause, when executed by the one or more processors, to further direct the computing system to:
submit, by the rubric engine, a request prompt to a content generator, wherein the request prompt comprises:
assignment instructions for the assignment to a content generator; and
a request for evaluation criteria based on the assignment instructions; and
receive, by the rubric engine, the one or more evaluation criteria for the rubric based on the assignment instructions from the content generator.

4. The system of claim 1, wherein the program instructions to generate, by the rubric engine, the rubric for the assignment based on the one or more evaluation criteria and the audience context for the assignment cause, when executed by the one or more processors, to further direct the computing system to:
generate, by the rubric engine, a first draft rubric based on the one or more evaluation criteria and the audience context for the assignment, wherein the first draft rubric comprises a first set of evaluation criteria across a first rubric scale;
receive, by the rubric engine, a modification to a first assessment within the first draft rubric; and
generate, by the rubric engine, the rubric comprising the one or more evaluation criteria across the rubric scale based on the first draft rubric and the modification.

5. The system of claim 1, wherein the program instructions to determine, by the rubric engine, the one or more evaluation criteria for the rubric based on the assignment type cause, when executed by the one or more processors, to further direct the computing system to:
generate, by the rubric engine, one or more recommended evaluation criteria;
provide, by the rubric engine, the one or more recommended evaluation criteria to the client device; and
receive, by the rubric engine, a selection of a first evaluation criteria from the one or more recommended evaluation criteria.

6. The system of claim 1, wherein the program instructions cause, when executed by the one or more processors, to further direct the computing system to:
receive, by the rubric engine, a completed assignment;
provide, by the rubric engine, the rubric associated with the completed assignment to the client device;
receive, by the rubric engine, selection of one or more assessments for the one or more evaluation criteria from the client device; and
generate, by the rubric engine, an overall assessment of the completed assignment.

7. A method for generating a rubric using a rubric engine operatively coupled to a generative artificial intelligence (GAI) model, the method comprising:
receiving, from a client device via a graphical user interface (GUI), an indication to generate the rubric for an assignment;
determining, by the rubric engine, an assignment type for the assignment;
determining, by the rubric engine, one or more evaluation criteria for the rubric based on the assignment type;
determining, by the rubric engine, a rubric scale for the rubric;
determining, by the rubric engine, audience context for the assignment;
generating, by the rubric engine, the rubric for the assignment based on the evaluation criteria and the audience context for the assignment, wherein:
the rubric comprises one or more assessments for each of the one or more evaluation criteria across the rubric scale;
the one or more assessments are modifiable by a user via the GUI on the client device; and
generating the rubric for the assignment comprises:
generating, by the rubric engine, a request prompt for the rubric, wherein the request prompt is configured to elicit a response from the GAI model and comprises the assignment type, the one or more evaluation criteria, the rubric scale, and the audience context; and
submitting, by the rubric engine, the request prompt to the GAI model which generates the rubric responsive to receiving the request prompt;
displaying, via the GUI on the client device, the rubric in a structured format that adjusts based on the one or more evaluation criteria, the rubric scale, and the one or more assessments; and
associating, by the rubric engine, the rubric with the assignment and a corresponding version history of the rubric.

8. The method of claim 7, wherein generating, by the rubric engine, the rubric for the assignment based on the one or more evaluation criteria and the audience context for the assignment comprises:
generating, by the rubric engine, a first draft rubric based on the one or more evaluation criteria and the audience context for the assignment, wherein the first draft rubric comprises a first set of evaluation criteria across a first rubric scale;
receiving, by the rubric engine, a modification to at least one of the first set of evaluation criteria or the first rubric scale; and
generating, by the rubric engine, the rubric comprising the one or more evaluation criteria across the rubric scale based on the first draft rubric and the modification.

9. The method of claim 7, wherein generating, by the rubric engine, the rubric for the assignment based on the one or more evaluation criteria and the audience context for the assignment comprises:
receiving, by the rubric engine, the rubric from the GAI model responsive to submitting the request prompt, wherein at least one of the one or more assessments within the rubric is presented to the user for optional modification prior to finalization.

10. The method of claim 7, wherein generating, by the rubric engine, the rubric for the assignment based on the one or more evaluation criteria and the audience context for the assignment further comprises:
receiving, by the rubric engine, a selection on a level of detail for the one or more assessments for each of the one or more evaluation criteria across the rubric scale; and
generating, by the rubric engine, the one or more assessments based on the selection, wherein each of the one or more assessments corresponds to a respective evaluation criteria of the one or more evaluation criteria and a respective scale factor on the rubric scale.

11. The method of claim 7, wherein generating, by the rubric engine, the rubric for the assignment based on the one or more evaluation criteria and the audience context for the assignment further comprises:
determining, by the rubric engine, a point-value for each scale factor of the rubric scale; and
assigning, by the rubric engine, a respective point-value to each scale factor of the rubric scale within the rubric.

12. The method of claim 7, wherein determining, by the rubric engine, the one or more evaluation criteria for the rubric comprises:
generating, by the rubric engine, a request prompt for generation of the one or more evaluation criteria, wherein the request prompt comprises:
assignment instructions for the assignment to a content generator; and
a request for evaluation criteria based on the assignment instructions; and
submit, by the rubric engine, the request prompt to a content generator, wherein the content generator generates the one or more evaluation criteria for the rubric based on the assignment instructions from the content generator.

13. The method of claim 7, wherein generating, by the rubric engine, the rubric for the assignment based on the one or more evaluation criteria and the audience context for the assignment further comprises:
determining, by the rubric engine, a point-value for each scale factor of the rubric scale; and
assigning, by the rubric engine, a respective point-value to each scale factor of the rubric scale within the rubric; and
the method further comprises:
identifying, by the rubric engine, a completed assignment associated with the rubric;
receiving, by the rubric engine, selection of one or more assessments for the one or more evaluation criteria from the client device;
determining, by the rubric engine, the point-value associated with each selected assessment; and
generating, by the rubric engine, an overall assessment of the completed assignment, wherein the overall assessment comprises an aggregation of the point-values of the selected assessments.

14. The method of claim 7, wherein the rubric engine comprises a generative artificial intelligence (AI) model.

15. A computer readable storage media comprising processor-executable instructions configured to cause one or more processors to:
receive, from a client device via a graphical user interface (GUI), an indication to generate a rubric for an assignment;
determine, by a rubric engine operatively coupled to a generative artificial intelligence (GAI) model, an assignment type for the assignment;
determine, by the rubric engine, one or more evaluation criteria for the rubric based on the assignment type;
determine, by the rubric engine, a rubric scale for the rubric;
determine, by the rubric engine, audience context for the assignment;
generate, by the rubric engine, the rubric for the assignment based on the one or more evaluation criteria and the audience context for the assignment, wherein:
the rubric comprises one or more assessments for each of the one or more evaluation criteria across the rubric scale;
the one or more assessments are modifiable by a user via the GUI on the client device; and
generating the rubric for the assignment comprises:
generating, by the rubric engine, a request prompt for the rubric, wherein the request prompt is configured to elicit a response from the GAI model and comprises the assignment type, the one or more evaluation criteria, the rubric scale, and the audience context; and
submitting, by the rubric engine, the request prompt to the GAI model which generates the rubric responsive to receiving the request prompt;
display, via the GUI on the client device, the rubric in a structured format that adjusts based on the one or more evaluation criteria, the rubric scale, and the one or more assessments; and
associate, by the rubric engine, the rubric with the assignment and a corresponding version history of the rubric.

16. The computer readable storage media of claim 15, wherein the processor-executable instructions to generate, by the rubric engine, the rubric for the assignment based on the one or more evaluation criteria and the audience context for the assignment cause the one or more processors to further execute processor-executable instructions stored in the computer readable storage media to:
receive, by the rubric engine, a selection on a level of detail for the one or more assessments for each of the one or more evaluation criteria across the rubric scale; and
generate, by the rubric engine, the one or more assessments based on the selection, wherein each of the one or more assessments corresponds to a respective evaluation criteria of the one or more evaluation criteria and a respective scale factor on the rubric scale.

17. The computer readable storage media of claim 15, wherein the processor-executable instructions to generate, by the rubric engine, the rubric for the assignment based on the one or more evaluation criteria and the audience context for the assignment cause the one or more processors to further execute processor-executable instructions stored in the computer readable storage media to:
generate, by the rubric engine, a first draft rubric based on the one or more evaluation criteria and the audience context for the assignment, wherein the first draft rubric comprises a first set of evaluation criteria across a first rubric scale;
receive, by the rubric engine, an indication to add a new evaluation criteria to the first set of evaluation criteria;
generate, by the rubric engine, a plurality of new assessments for the new evaluation criteria across the rubric scale; and
generate, by the rubric engine, the rubric based on the first draft rubric and the new evaluation criteria, wherein the one or more evaluation criteria comprise the new evaluation criteria.

18. The computer readable storage media of claim 15, wherein the processor-executable instructions to determine, by the rubric engine, one or more evaluation criteria for the rubric based on the assignment type cause the one or more processors to further execute processor-executable instructions stored in the computer readable storage media to:
generate, by the rubric engine, one or more recommended evaluation criteria;
provide, by the rubric engine, the one or more recommended evaluation criteria to the client device; and
receive, by the rubric engine, a selection of a first evaluation criteria from the one or more recommended evaluation criteria.

19. The computer readable storage media of claim 15, wherein the processor-executable instructions cause the one or more processors to further execute processor-executable instructions stored in the computer readable storage media to:
responsive to receiving, from the client device, the indication to generate the rubric, determine, by the rubric engine, one or more recent rubrics; and
provide, by the rubric engine, the one or more recent rubrics to the client device.

20. The computer readable storage media of claim 15, wherein the processor-executable instructions cause the one or more processors to further execute processor-executable instructions stored in the computer readable storage media to:
save, by the rubric engine, the rubric to a rubric database at a first time;
receive, by the rubric engine, an indication to generate a second rubric at a second time;
receive, by the rubric engine, a selection of the rubric from the rubric database;
modify, by the rubric engine, the rubric based on input from a client device; and
generate, by the rubric engine, the second rubric based on the input from the client device.
